(19) United States
(12) Patent Application Publication
(10) Pub. No.: US 2016/0236420 A1
(43) Pub. Date: Aug. 18, 2016

(54) PRINTBED

(71) Applicants: Michael Daniel Armani, Bethesda, MD (US); David Souza Jones, Burtonsville, MD (US)

(72) Inventors: Michael Daniel Armani, Bethesda, MD (US); David Souza Jones, Burtonsville, MD (US)

(21) Appl. No.: 14/841,678

(22) Filed: Aug. 31, 2015

Related U.S. Application Data
(60) Provisional application No. 62/117,439, filed on Feb. 17, 2015.

(51) Int. Cl. B29C 67/00

(52) U.S. Cl. CPC B29C 67/0092; B29K 2995/0037; B33Y 30/00

(57) ABSTRACT

A printbed for 3D printers and 3D printed objects has a hole size and thickness that facilitates release of the printed object, that is sufficiently strong to provide a stable base, and that does not cause warping of the printed object either during printing or during release of the object from the printbed.

### CROSS REFERENCE TO RELATED APPLICATIONS

This application claims the priority of Provisional Application No. 62/117,439 filed on Feb. 17, 2015, inventors Michael Daniel Armani and David Souza Jones, entitled “3D Printer”. The entire disclosure of this provisional patent application is hereby incorporated by reference thereto, in its entirety.

### STATEMENT REGARDING FEDERALLY SPONSORED RESEARCH OR DEVELOPMENT

Not applicable.

### FIELD OF THE INVENTION

The present invention relates to an improved printbed for 3D printers and 3D printed objects.

### BACKGROUND OF THE INVENTION

It is a problem in the art to provide a printbed for 3D printers and 3D printed objects that facilitates release of the printed object, that is sufficiently strong to provide a stable base, and that does not cause warping of the printed object either during printing or during release of the object from the printbed.

Prior art printbeds for 3D printing have known problems in releasing delicate parts and may cause warping, damage to the printbed itself, and damage to the printed object.

In the 3D printer industry, the industry standard printbeds have an array of perforations that can fail to release 3D printed support rafts. This is because the holes are relatively tiny, about 1.15 mm. These standard printbeds are well known to use a standard 1.55-1.60 mm thick PCB (fr-4 type phenolic).

### SUMMARY OF THE INVENTION

From the foregoing, it is seen that it is a problem in the art to provide a device meeting the above requirements. According to the present invention, a device is provided which meets the aforementioned requirements and needs in the prior art. Specifically, the device according to the present invention provides a printbed for 3D printers and 3D printed objects that facilitates release of the printed object, that is sufficiently strong to provide a stable base, and that does not cause warping of the printed object either during printing or during release of the object from the printbed.

The present invention employs a novel structure having openings in a specified size ranges, and employing specific materials, such that the printbed facilitates release of the printed object, is sufficiently strong to provide a stable base, and does not cause warping of the printed object either during printing or during release of the object from the printbed.

Other objects and advantages of the present invention will be more readily apparent from the following detailed description when read in conjunction with the accompanying drawings.

### BRIEF DESCRIPTION OF THE DRAWINGS

FIG. 1 is a schematic front view of a 3D printer and printbed, depicting an object being printed.

FIG. 2 is a top view of a portion of a printbed surface showing holes therein.

FIG. 3 is a front view of the printbed of FIG. 2.

FIG. 4 is a greatly enlarged perspective sectional view of the printbed surface of FIG. 2, showing the holes therethrough.

FIG. 5 is a perspective view of a printbed holder supporting by the printbed of FIGS. 2-5. A sectional view goes through the printbed, but not the printbed holder.

### DETAILED DESCRIPTION OF THE INVENTION

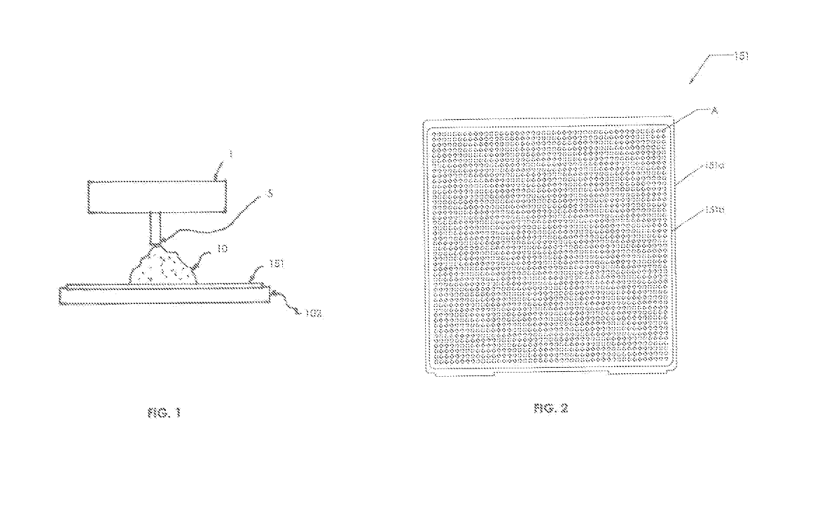

FIG. 1 is a schematic front view of a 3D printer 1 having a printhead 5 in the process of producing a printed object 10. The object 10 is supported on a printbed 151. The printbed 151 is supported by a holder 102. The elements shown in FIG. 1 are for illustrative purposes only.

In the present invention, experiments have shown that a perforated hole size with a very fine range of about 1.25 mm-1.6 mm is significantly better in use that the industry standard size. This hole size works well with a standard size PCB having a thickness of 1.55-1.60 mm, and works even better with a double layer having a thickness of 3.2 mm, discussed further below.

The above-noted hole size is also shown by experiments to be most useful when incorporated in a printbed having a thickness of 3.2 mm. Such a printbed is formed by two 1.55 mm thick PCBs bonded together, as described below. This particular hole structure worked better for a 1.55 mm thick PCB, allowing prints (printed objects) to avoid warping but still allowing release of the rafts. Even more unique to the present invention though, is the use of two PCB's thermally bonded or glued together to make a 3.2 mm PCB. These PCB's work better with a 1.4 mm-1.8 mm hole size, trapping plastic even better for the purpose of preventing warp (due to longer holes but stiffer bed), and still allowing release. In an alternative embodiment, a PCB is manufactured to be 3.2 mm in thickness so gluing or thermal bonding is not required.

The improved performance from an enlargement in hole size, as compared with the prior art, is an unexpected result. Intuitively, it had been thought and expected that a reduction in hole size would provide better results since less material can get into smaller holes.

Therefore, the greatly improved performance with the print bed of the present invention, by use of large hole sizes, is an unexpected and surprising result.

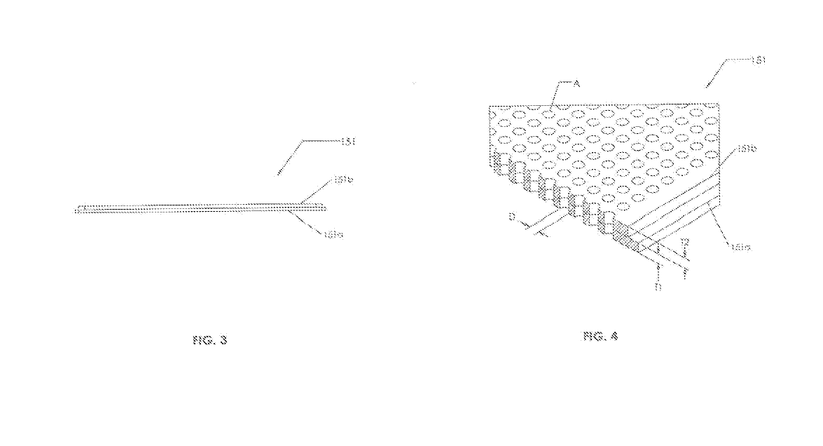

FIG. 2 is a top view of a portion of a printbed 151 according to the present invention, having a top member 151b and showing a plurality of holes A therein. The printbed 151 is described in further detail hereunder.

FIG. 3 is a front elevational view of the printbed 151 of FIG. 2. In this view, the printbed 151 has the top member 151b and a bottom member 151a. The printbed 151 and the members 151b and 151a are described in further detail hereunder.

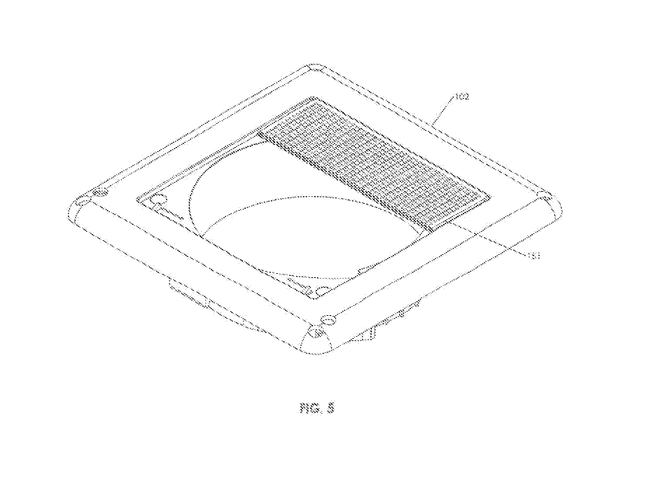

FIG. 4 is a greatly enlarged perspective view of a portion of the surface of the printbed 151 of FIG. 2, showing the holes A therethrough. It can be seen that the holes A line up on both top member 151b and the bottom member 151a. In this view, the thickness of the top member 151b is indicated by the symbol T2, and the thickness of the bottom member 151a is indicated by the symbol T1.

Here, T1 is equal to 1.55-1.60 mm, and T2 is equal to 1.55-1.60 mm. The material composing the members 151b and 151a is a standard PCB material. In this view, the diameter of the respective ones of the holes A is indicated by the symbol D. Here, D is in a range of about 1.25 mm-1.6 mm.

FIG. 5 is a top elevational view of the printbed 151 of FIGS. 2-5 supported by a printbed holder 102. While a specific printbed holder 102 is depicted, the present invention is not limited thereto.

The printbed holder 102 in this instance is a large box housing, which leaves the bottom surface of the bottom member 151a exposed to air to allow ventilation. This is significant since the holes A go all the way through both layers 151b and 151a of the printbed 151. This ventilation is important because otherwise air prevents the plastic from going into the holes A sufficiently well.

In the foregoing the dimension range for D (1.25 mm to 1.6 mm) as set forth hereinabove is a critical range.

The combined thicknesses T1 and T2 combine to form a preferred printbed thickness that is substantially equal to 3.2 mm. Other thicknesses can be used, and the preferred thickness is not a critical range.

The invention being thus described, it will be evident that the same may be varied in many ways by a routineer in the applicable arts. Such variations are not to be regarded as a departure from the spirit and scope of the invention and all such modifications are intended to be included within the scope of the claims.

What is claimed is:

1. A printbed for 3D printers and 3D printed objects that facilitates release of the printed object, comprising:
a thin sheet-like body; and
a plurality of holes disposed in said body; said body being sufficiently strong to provide a stable base, and that does not cause warping of the printed object either during printing or during release of the object from the printbed.

2. The printbed of claim 1, wherein the dimension range for the hole diameter is 1.25 mm to 1.6 mm, and the body thickness is substantially equal to 3.2 mm.

3. The printbed of claim 2, wherein the thickness of said body is substantially equal to 3.2 mm.
